(19) United States
(12) Patent Application Publication
(10) Pub. No.: US 2025/0229562 A1
(43) Pub. Date: Jul. 17, 2025

(54) Multi-fold and multi-flap workbook tool

(71) Applicant: Gradient Financial Group, LLC, Arden Hills, MN (US)

(72) Inventors: Tami Jean Lucius, Scottsdale, AZ (US); Charles Edward Lucius, Scottsdale, AZ (US)

(21) Appl. No.: 19/016,314

(22) Filed: Jan. 10, 2025

Related U.S. Application Data
(60) Provisional application No. 63/619,869, filed on Jan. 11, 2024.

(51) Int. Cl. B42D 15/00

(52) U.S. Cl. CPC B42D 15/008

(57) ABSTRACT

An interactive workbook tool for conveying information provided on a plurality of information display surfaces and configured with plurality of folds and a plurality of tabs, which allow for multiple uses of the workbook as a user can be guided through the workbook and information therein in various sequences and in manners where information on one or more tabs is easily accessible for forward or backward reference. The information on the tabs can be viewed in a plurality of manners including in one or more sequences and concurrently. Multiple tabs can be viewed concurrently and individually based on use of a plurality of fold lines and a plurality of cut lines, allowing for a customizes visualization and user experience.

### CROSS-REFERENCE TO RELATED APPLICATION

This application claims priority to and the benefit of U.S. provisional patent application Ser. No. 63/619,869, filed on Jan. 11, 2024, the contents of which are incorporated herein in their entirety.

### BACKGROUND

Display materials and literature such as brochures, workbooks and the like generally are limited to parallel folds, such that the materials include bifold, z-fold, accordion and roll folds.

### SUMMARY

An aspect of the present disclosure relates to a workbook display comprising a base comprising a plurality of fold lines; and a plurality of tabs connected to the base and extending away therefrom, wherein each of the base and the plurality of tabs comprises a data display surface.

The plurality of fold lines comprises a first plurality of fold lines spaced apart from one another and extending across a width of the base and a second plurality of fold lines provided along a first side length and a second side length of the base.

The plurality of tabs comprise a first a plurality of tabs extending from a first side length of the base and a second plurality of tabs extending from a second side length of the base.

The plurality of tabs further comprise at least one tab extending from an end length of the base.

Each tab of the plurality of tabs extends from the base at a fold line between the tab and the base and is also separated from an adjacent tab of the plurality of tabs by a cut line such that each tab of the plurality of tabs is independently foldable with respect to the base.

The first plurality of fold lines comprises at least three fold lines spaced apart on the base.

The first plurality of fold lines spaced apart on the base divide the base into a plurality of display surfaces.

The workbook display is comprised of paper, coated paper, cardstock or combinations thereof.

The data display surfaces of each of the base and the plurality of tabs comprise text, images, and combinations thereof and wherein each display surface of the plurality of display surfaces comprises the same or different text, images or combinations thereof.

The workbook display folds closed to a first position where each tab of the plurality of tabs is concealed by the base folded along at least one of the plurality of fold lines.

The workbook display unfolds open to at least one second position where each tab of the plurality of tabs is exposed and the base is exposed for viewing.

### BRIEF DESCRIPTION OF THE DRAWINGS

FIG. 1 is a top view of the multi-fold and multi-flap tool in an open position.

FIG. 2 is a top view of a die cut for forming the tool.

FIG. 3 is a top view of the multi-fold and multi-flap tool in a closed position.

FIG. 4 is a top view of the multi-fold and multi-flap tool in an alternative closed position.

FIG. 5 is a side view of the multi-fold and multi-flap tool in a closed position.

FIGS. 6A-6D illustrate a method of folding the multi-fold and multi-flap tool.

### DETAILED DESCRIPTION

An interactive workbook tool for conveying information provided on a plurality of information display surfaces is described herein. The workbook tool is configured with plurality of folds and a plurality of tabs, which allow for multiple uses of the workbook as a user can be guided through the workbook and information therein in various sequences and in manners where information on one or more tabs is easily accessible for forward or backward reference. The information on the tabs can be viewed in a plurality of manners including in one or more sequences and concurrently. Multiple tabs can be viewed concurrently and individually based on use of a plurality of fold lines and a plurality of cut lines, allowing for a customizes visualization and user experience.

The workbook tool generally comprises a base comprising one, two, three, four or more information display surfaces and a plurality of tabs connected to the base, each tab being connected to the base by a fold line. The tabs may then be separated from adjacent tabs connected to the base by a cut line. For example, there may be six, seven, eight, nine, or more tabs connected to the base, each connected to the base by a single fold line and separated from each of the remaining tabs by a cut line. Thus, in one embodiment, each of the tabs are independently foldable with respect to the base and thus of a pair of adjacent tabs, one may be folded to a closed position with the base exposing a back surface of the tab and one may be open with respect to the base, exposing a front surface thereof.

The base itself comprises one, two, three, or more fold lines spaced apart along a length thereof. This separates the base into two, three, four or more segments where each segment is a display surface. The fold lines may each be used to close the workbook or some fold lines may be used to close the workbook.

Each segment may have one, two or more tabs connected via a fold line to a perimeter side not connected via a fold line to an adjacent base segment. This also allows the base to be further folded and/or partially folded upon itself with or without the respective connected tab(s) folded “in”. Thus, each segment and tab can be individually and selectively exposed and/or exposed in a pre-selected sequence to guide a user through the information contained on each display surface. Further, the multi-use expanding and folding of the display surfaces of the workbook tool allows for various uses, including compact storage and transport of the workbook too.

What is meant by “display surface” as used herein is a surface area for printing thereon and/or otherwise displaying text, images, data, or other content on a front and/or back side thereof. Each display surface may be bounded by a fold line(s), cut line(s), and/or combinations thereof on one or more sides thereof.

What is meant by “fold line” as used herein is a channel or indentation providing a location for folding and unfolding two components, such as segments and/or tabs while the two components remain otherwise coupled and connected. The fold line may be reinforced or otherwise allow for multiple rounds of folding and unfolding without separating the segments and/or tabs from the base of the workbook. The fold lines may also be sufficient in strength and/or reinforcement to allow for folding of the two components about the fold line in different directions, such that two components may be folded with a first face facing each other or with the first faces facing away from each other using the same fold line. Combinations of folding about different fold lines also allows for a plurality of different orientations and constructions of a “folded” tool.

What is meant by “cut line” as used herein is a separation between two components along the length of said cut line. Cut lines may be formed by die cutting, laser cutting or the like.

The workbook tool may be constructed of various materials including paper products such as cardstock, coated papers, tag board, or the like.

The workbook tool may be provided with various overall dimensions (e.g., total length and total width) ranging from less than about 8 in×11 in to greater than about 34 in×22 in or greater. The workbook has multiple configurations via selective use of the fold lines provided on the base and/or as connected to the tabs. In one embodiment, in an open configuration wherein the workbook is completed unfolded (e.g., flat) the overall dimensions of the workbook include a length of about 34½ inches, a width of about 22 inches and a thickness of about 1/64 of an inch. When folded to a compact workbook (e.g., all folds utilized) the workbook has an overall length of about 11 inches, an overall width of about 7 inches and a thickness of about ¼ inch. That is, the configuration of the workbook allows for reduction in overall length and width for storage.

Further embodiments allow for only some of the folds to be used, or for various combinations of folds to be used where utilizing the various fold lines in different sequences allows for alternative views and uses of the workbook tool.

The workbook comprises folds and/or fold lines along two axes, wherein the axes are not parallel to one another. The workbook comprises folds in at least two directions, allowing for additional formation of a compact workbook.

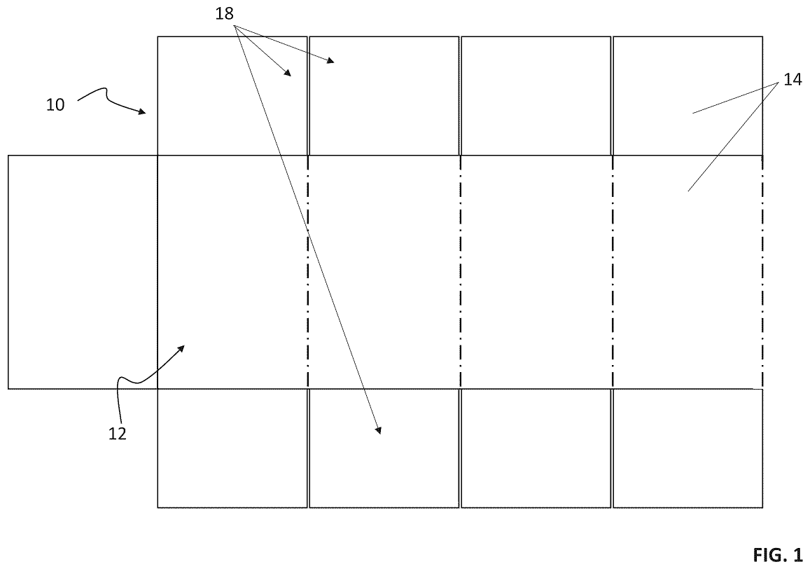

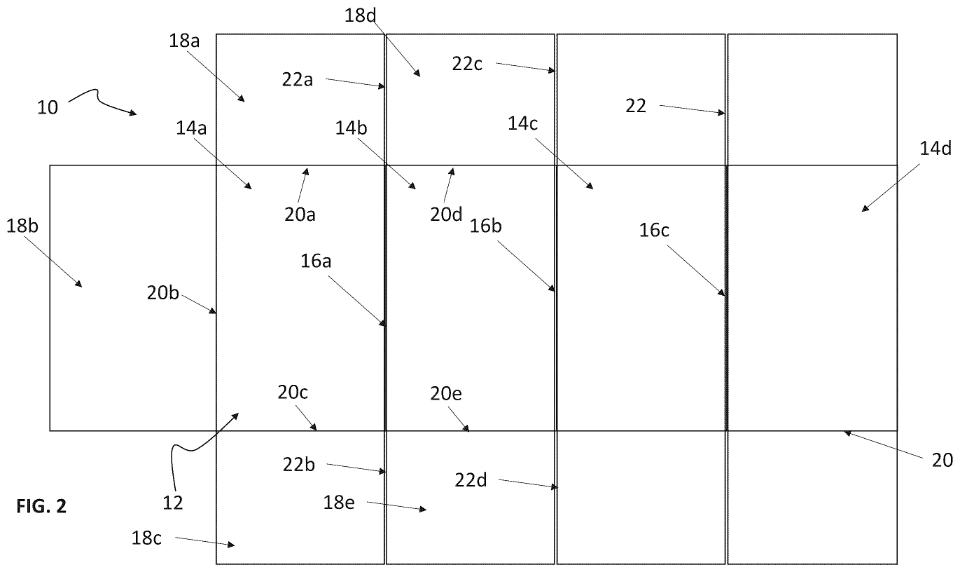

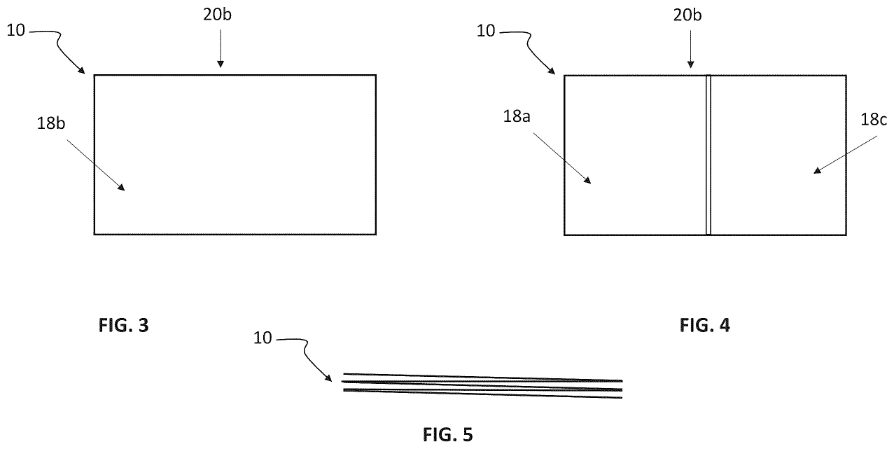

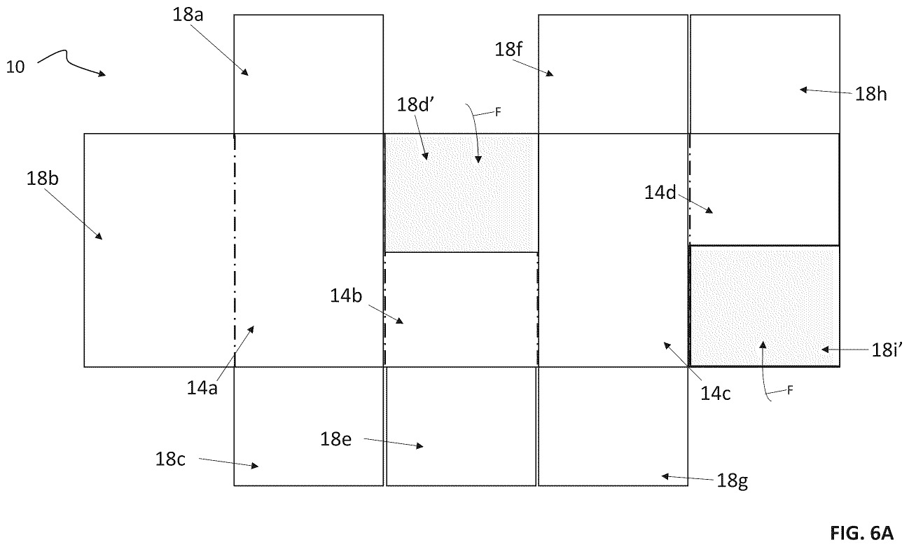

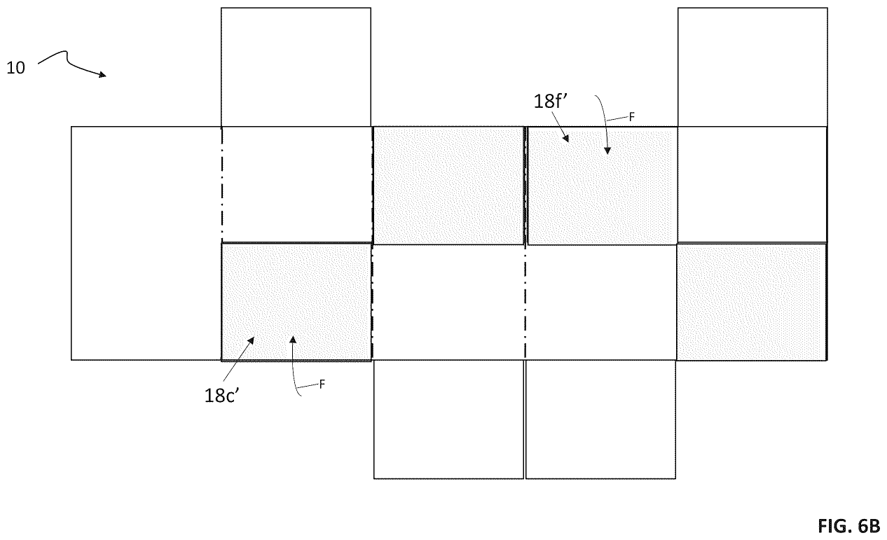

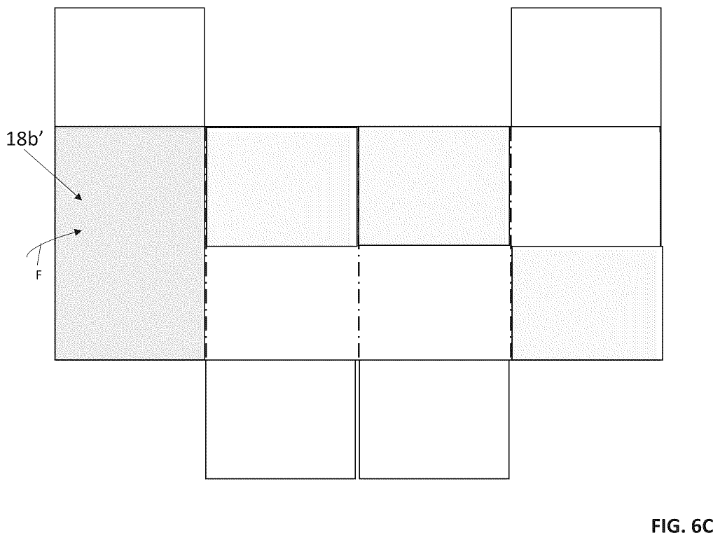

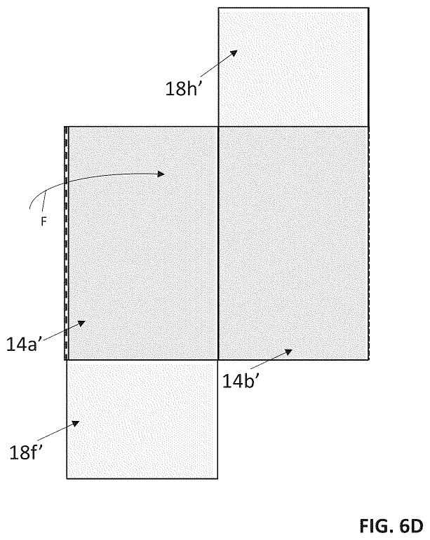

In the embodiment illustrated in FIGS. 1-4, the workbook 10 comprises a base 12 that is divided into four segments 14a, 14b, 14c, 14d. Each segment 14a-d is also a display surface 14 for text, graphics or the like. The display surface 14 may be on one or both faces of the segment as shown by reference characters 14a, 14a′, 14b, 14b′, 14c, 14d (reverse sides not shown’ for example in FIG. 6D. The text, graphics or other content printed on each segment, tab 18a-18i, 18a′18i′ or base area may be the same or different and may span across one or more adjacent or spaced apartment segments, tabs, or bases. The front and back surfaces may each serve as a display surface for the same or different content and content may span one or more surfaces and faces congruently or incongruently depending on intended or actual folding. As shown in FIGS. 1-3, the segments 14a, 14b, 14c, 14d are connected to adjacent segments via a fold line 16. As illustrated, a first segment 14a is connected to segment 14b by a fold line 16a, and segment 14b is connected to segment 14c by a fold line 16b and segment 14c is connected to segment 14d by a fold line 16c. A plurality of tabs 18 are connected to the base via fold lines 20. For example, three tabs 18a, 18b, and 18c extend from base segment 14a via respective fold lines 20a, 20b, and 20c while only two tabs 18d, 18e extend from base segment 14b via fold lines 20d, 20e.

As tabs 18a and 18d are adjacent tabs 18 and extend from the base 12 on a same side of the base, a cut line 22a is provided between the tabs 18a and 18d, which allow tabs 18a and 18d to independently fold for opening and closing with respect to the base 12 and respective segments 14a and 14b. Cut lines 22 are provided between adjacent tabs to allow for independent and selective folding.

The tabs 18 may be provided on both sides of the workbook 10, for example, segment 14a has the first side tab 18a and the opposing second side tab 18c and thus segment 14b has the first side tab 18d and the second opposing side tab 18e. These opposing side tabs 18a and 18c as well as 18d and 18e are independently foldable such that tabs 18a and 18c may fold over one or the other when closing over the base segment 14a. While each tab 18 can be folded closed or opened with respect to the display surface of the base 12, each tab can fold over or under another tab 18 on the opposing side of the base 12.

The segments may also fold over an adjacent segment, such that segment 14a may be folded over to face segment 14b. Moreover, the ordering of folds indicates that adjacent segments may not be folded sequentially or in the same direction. This allows the workbook to be selectively configured and conformed and one or more display surfaces concurrently visible and accessible.

Although the present disclosure has been described with reference to preferred embodiments, workers skilled in the art will recognize that changes may be made in form and detail without departing from the spirit and scope of the disclosure.

1. A workbook display comprising:
a base comprising a plurality of fold lines; and
a plurality of tabs connected to the base and extending away therefrom,
wherein each of the base and the plurality of tabs comprises a data display surface.

2. The workbook display of claim 1 wherein the plurality of fold lines comprises a first plurality of fold lines spaced apart from one another and extending across a width of the base and a second plurality of fold lines provided along a first side length and a second side length of the base.

3. The workbook display of claim 1 wherein the plurality of tabs comprise a first a plurality of tabs extending from a first side length of the base and a second plurality of tabs extending from a second side length of the base.

4. The workbook display of claim 3 wherein the plurality of tabs further comprise at least one tab extending from an end length of the base.

5. The workbook display of claim 4 wherein each tab of the plurality of tabs extends from the base at a fold line between the tab and the base and is also separated from an adjacent tab of the plurality of tabs by a cut line such that each tab of the plurality of tabs is independently foldable with respect to the base.

6. The workbook display of claim 1 wherein the first plurality of fold lines comprises at least three fold lines spaced apart on the base.

7. The workbook display of claim 6 wherein the first plurality of fold lines spaced apart on the base divide the base into a plurality of display surfaces.

8. The workbook display of claim 1 wherein the workbook display is comprised of paper, coated paper, cardstock or combinations thereof.

9. The workbook display of claim 1 wherein the data display surfaces of each of the base and the plurality of tabs comprise text, images, and combinations thereof and wherein each display surface of the plurality of display surfaces comprises the same or different text, images or combinations thereof.

10. The workbook display of claim 1 wherein the workbook display folds closed to a first position where each tab of the plurality of tabs is concealed by the base folded along at least one of the plurality of fold lines.

11. The workbook display of claim 10 wherein the workbook display unfolds open to at least one second position where each tab of the plurality of tabs is exposed and the base is exposed for viewing.
